(19) United States
(12) Patent Application Publication
(10) Pub. No.: US 2026/0111117 A1
(43) Pub. Date: Apr. 23, 2026

(54) STORAGE DEVICE STORING RANDOMLY READ DATA UNITS AND METHOD FOR OPERATING STORAGE DEVICE

(71) Applicant: SK hynix Inc., Icheon-si (KR)

(72) Inventor: Jung Woo KIM, Icheon-si (KR)

(21) Appl. No.: 19/052,683

(22) Filed: Feb. 13, 2025

(30) Foreign Application Priority Data
Oct. 22, 2024 (KR) 10-2024-0144484

(51) Int. Cl. G06F 3/06

(52) U.S. Cl. CPC G06F 3/0613; G06F 3/0659; G06F 3/0673

(57) ABSTRACT

A storage device may include a memory and a controller. The memory may include memory blocks, and may store data in the memory blocks. The controller may set memory areas each including one or more memory blocks among the memory blocks, may receive a first random read request from an outside of the storage device, may read first data units among data units stored in a plurality of memory areas from the memory in response to the first random read request, and may store the first data units in in a random read memory area. The random read memory area includes one or more memory blocks and is separate from the memory areas.

### CROSS-REFERENCE TO RELATED APPLICATION

The present application claims priority under 35 U.S.C. § 119(a) to Korean Patent Application No. 10-2024-0144484 filed in the Korean Intellectual Property Office on Oct. 22, 2024, which is incorporated herein by reference in its entirety.

### BACKGROUND

### 1. Technical Field

Embodiments of the present disclosure relate to a storage device which stores randomly read data units, and a method for operating a storage device.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (e.g., a host), and execute or control operations to read, write, or erase data in the memory included in the storage device according to the received command.

The controller may receive a random read request from the host, and, in response to the random read request, may randomly read data units stored at a random location in the memory. Random read performance may vary depending on a location where data units are stored. When data units are stored at a location where the data units can be read in parallel, random read performance increases, but when data units are stored at a location where the data units cannot be read in parallel, random read performance decreases.

### SUMMARY

Various embodiments of the present disclosure are directed to providing a storage device and a method for operating a storage device, capable of improving the performance of a random read operation.

In an aspect, a storage device may include: a memory including a plurality of memory blocks and being configured to store data in the plurality of memory blocks; and a controller configured to set a plurality of memory areas each including at one or more memory blocks among the plurality of memory blocks, receive a first random read request from an outside of the storage device, read first data units among data units stored in the plurality of memory areas from the memory in response to the first random read request to transmit the first data units to the outside of the storage device, and store the first data units in a random read memory area. The random memory area includes one or more memory blocks and is separate from the plurality of memory areas.

In another aspect, a method for operating a storage device may include: receiving a first random read request from an outside of the storage device; reading first data units among data units stored in a plurality of memory areas in response to the first random read request, each of the plurality of memory areas including one or memory blocks among a plurality of memory blocks; and storing the first data units in a random read memory area that includes one or more memory blocks and is separate from the plurality of memory areas.

According to embodiments of the present disclosure, it is possible to improve the performance of a random read operation.

### BRIEF DESCRIPTION OF THE DRAWINGS

FIG. 1 is a schematic configuration diagram of a storage device according to an embodiment of the present disclosure.

FIG. 2 is a block diagram schematically illustrating a memory of FIG. 1.

FIG. 3 is a diagram illustrating schematic structure of a storage device according to an embodiment of the present disclosure.

FIG. 4 is a diagram illustrating an operation in which a storage device processes a first random read request according to an embodiment of the present disclosure.

FIG. 5 is a flowchart illustrating an operation in which a storage device determines whether to write first data units to a random read memory area, according to an embodiment of the present disclosure.

FIG. 6 is a diagram illustrating an operation in which a storage device writes first data units to a random read memory area, according to an embodiment of the present disclosure.

FIG. 7 is a diagram illustrating a random read map table according to an embodiment of the present disclosure.

FIG. 8 is a diagram illustrating sub-random read memory areas included in a random read memory area according to an embodiment of the present disclosure.

FIG. 9 is a diagram illustrating an operation in which a storage device according to an embodiment of the present disclosure processes a second random read request.

FIG. 10 is a diagram illustrating an operation in which a storage device according to an embodiment of the present disclosure reads second data units.

FIG. 11 is a diagram illustrating an operation in which a storage device erases a memory block included in a random read memory area according to an embodiment of the present disclosure.

FIG. 12 is a diagram illustrating a method for operating a storage device according to an embodiment of the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily to only a single embodiment, and different references to any such phrase are not necessarily limited to the same embodiment(s). The term “embodiments” when used herein does not necessarily refer to all embodiments.

Various embodiments of the present disclosure are described below in more detail with reference to the accompanying drawings. However, embodiments of the present disclosure may be implemented in different forms and variations, and should not be construed as being limited to the embodiments set forth herein. Rather, the described embodiments are provided so that this disclosure will be thorough and complete, and will fully convey the present disclosure to those skilled in the art to which this disclosure pertains. Throughout the disclosure, like reference numerals refer to like parts throughout the various figures and embodiments of the present disclosure.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

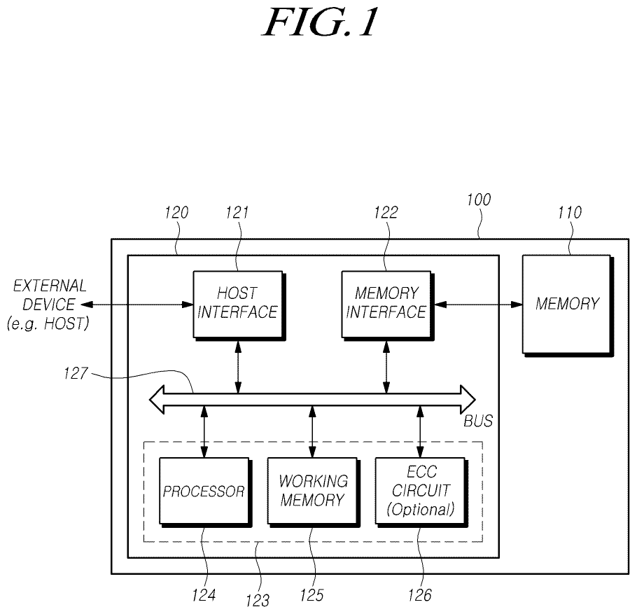

FIG. 1 is a schematic configuration diagram of a storage device 100 according to an embodiment of the disclosure.

Referring to FIG. 1, the storage device 100 may include a memory 110 that stores data and a controller 120 that controls the memory 110.

The memory 110 includes a plurality of memory blocks, and operates in response to the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of the disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (program), read, erase and background operations for the memory 110. For example, background operations may include one or more from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request of the host.

The host may be a computer, an ultra-mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into a single device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses one or more from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 in response to the control of the control circuit 123.

The control circuit 123 performs the general control operations of the controller 120 to control the operation of the memory 110. To this end, for instance, the control circuit 123 may include one or both of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (drive) firmware loaded in the working memory 125 upon booting. Hereafter, as an example, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include one or more from among a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, one or more from among an SRAM (static RAM), a DRAM (dynamic RAM) and an SDRAM (synchronous DRAM). Meanwhile, the controller 120 may additionally use a separate volatile memory (e.g. SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may refer to a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or a fail. On the other hand, when a bit error rate is lower than the reference value, the error detection and correction circuit 126 may determine that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into a single component. In addition to the above-described components 121, 122, 124, 125 and 126 of the controller 120, one or more other components may be added.

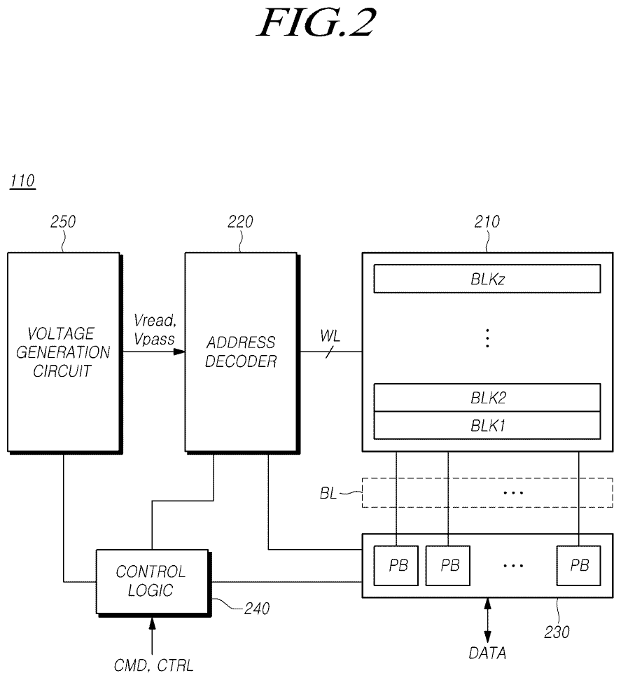

Hereinbelow, the memory 110 will be described in further detail with reference to FIG. 2.

FIG. 2 is a block diagram schematically illustrating a memory 110 of FIG. 1.

Referring to FIG. 2, the memory 110 according to an embodiment of the disclosure may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include one or more from among a block address, a row address and a column address.

The address decoder 220 may select a single memory block and a single word line depending on a block address and a row address. A column address may be decoded by the address decoder 220 and be provided to the read and write circuit 230.

The address decoder 220 may include one or more from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. As an embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to a corresponding one of the plurality of word lines WL and a corresponding one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (or a write operation) of the memory block described above may be performed by the unit of a page, and an erase operation may be performed by the unit of a memory block.

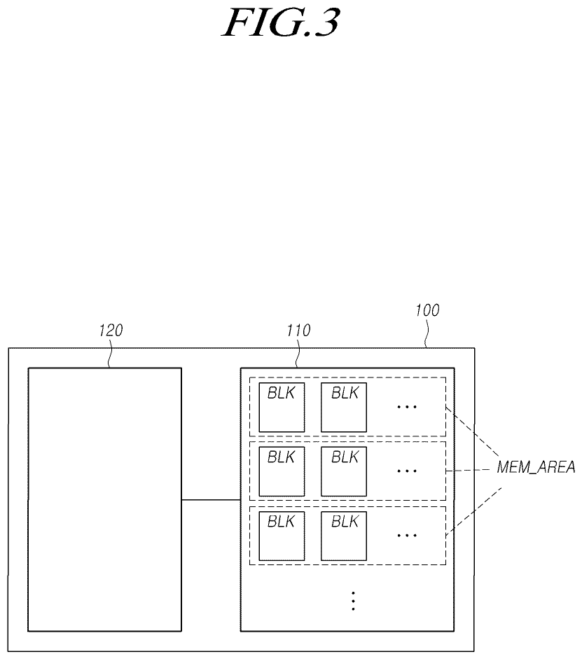

FIG. 3 is a diagram illustrating the schematic structure of a storage device 100 according to an embodiment of the present disclosure.

Referring to FIG. 3, the storage device 100 may include a memory 110 and a controller 120.

The memory 110 may include a plurality of memory blocks BLK. The memory 110 may store data (e.g., data units) in the plurality of memory blocks BLK. The size of each data unit may be a multiple of the size (e.g., 4KB) of a page included in each of the plurality of memory blocks BLK.

The controller 120 may set a plurality of memory areas MEM_AREA. Each of the plurality of memory areas MEM_AREA may include one or more memory blocks among the plurality of memory blocks BLK. Each of the plurality of memory areas MEM_AREA may be referred to as a zone, a super memory block, a memory container, etc.

Address mapping for the plurality of memory areas MEM_AREA may be performed by the unit of memory block. That is to say, each of memory blocks included in the plurality of memory areas MEM_AREA may be mapped to a single consecutive logical address area, and data may be sequentially stored in a single memory block.

The controller 120 may receive a random read request for data units stored in the plurality of memory areas MEM_AREA from the outside (e.g., a host) of the storage device 100.

The random read request may be a request to read one or more data units each having a preset size (e.g., 4KB).

The random read request may include logical addresses corresponding to the one or more data units. For example, the number of the logical addresses is the same as the number of the data units, and the logical addresses corresponding to the one or more data units may be arbitrary logical addresses. The logical addresses may be non-consecutive and non-sequential.

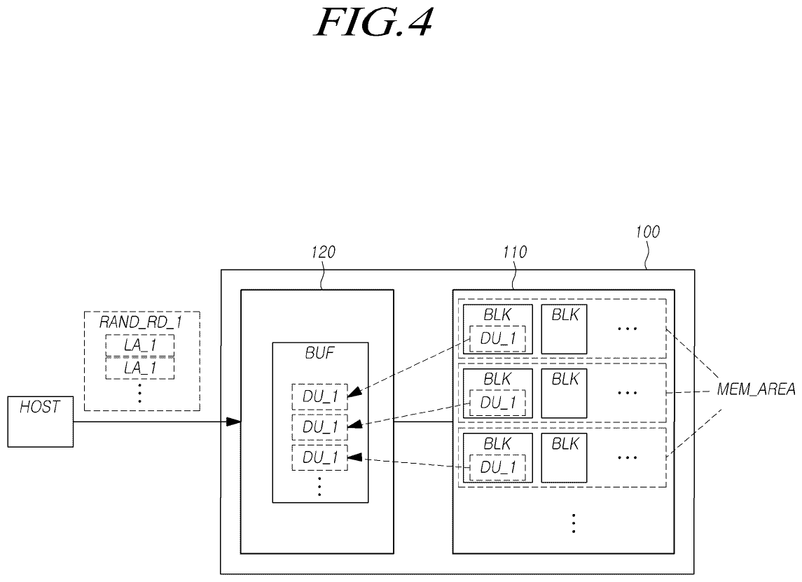

Hereafter, an operation in which the controller 120 processes the random read request received from the host will be described with reference to FIG. 4.

FIG. 4 is a diagram illustrating an operation in which a storage device (e.g., the storage device 100 in FIG. 3) processes a first random read request RAND_RD_1, according to an embodiment of the present disclosure.

Referring to FIG. 4, the controller 120 of the storage device 100 may receive a first random read request RAND_RD_1 from the outside (e.g., a host HOST) of the storage device 100. The first random read request RAND_RD_1 may include information on a plurality of first target logical addresses LA_1.

The first random read request RAND_RD_1 may request the controller 120 to read data units corresponding to the plurality of first target logical addresses LA_1. The first random read request RAND_RD_1 may be composed of one or more read commands.

In response to the first random read request RAND_RD_1, the controller 120 may read first data units DU_1 among data units stored in the plurality of memory areas MEM_AREA. The controller 120 may randomly read the first data units DU_1.

The controller 120 may read in parallel the first data units DU_1 which can be read simultaneously. Therefore, when the first data units DU_1 can be read in parallel (e.g., the first data units DU_1 are stored in different memory dies), random read performance increases, compared to when the first data units DU_1 cannot be read in parallel (e.g., the first data units DU_1 are stored in different memory blocks on the same plane).

A location where each of the first data units DU_1 is stored is not limited to the embodiment of FIG. 4, and each of the first data units DU_1 may be stored in any memory block of any memory area among the plurality of memory areas MEM_AREA.

The controller 120 may store the randomly read first data units DU_1 in a buffer BUF. The buffer BUF may temporarily store the randomly read first data units DU_1 before transmitting them to the host HOST. The first data units DU_1 stored in the buffer BUF may be deleted from the buffer BUF after being transmitted to the host HOST.

The buffer BUF may be implemented in various ways. For example, the buffer BUF may be implemented as a memory (e.g., the working memory 125 in FIG. 1) included in the controller 120. For another example, the buffer BUF may be a separate volatile memory which is located inside or outside the controller 120.

In embodiments of the present disclosure, the controller 120 may determine whether to store the first data units DU_1 stored in the buffer BUF in a random read memory area including one or more memory blocks among the plurality of memory blocks BLK.

For example, the random read memory area may include one or more memory blocks which is not included in the plurality of memory areas MEM_AREA among the plurality of memory blocks BLK. In other words, the random read memory area may be separate from the plurality of memory areas MEM_AREA (e.g., exist separately without overlapping the plurality of memory areas MEM_AREA).

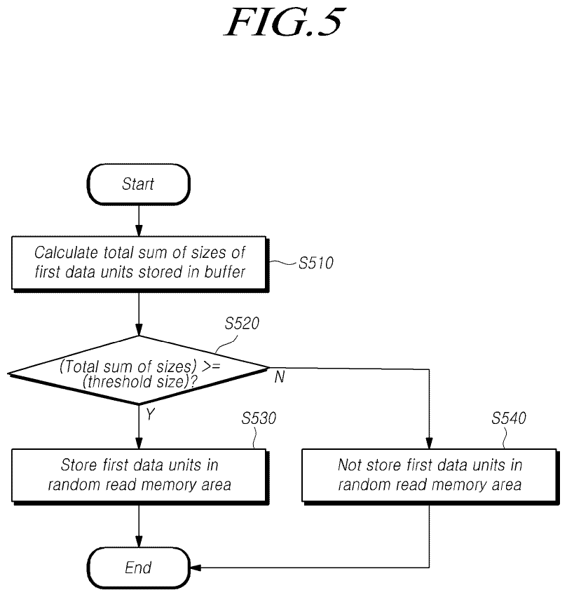

This will be described below in detail with reference to FIG. 5.

FIG. 5 is a flowchart illustrating an operation in which a storage device (e.g., the storage device 100) determines whether to write first data units DU_1 to a random read memory area, according to an embodiment of the present disclosure.

Referring to FIG. 5, the controller 120 of the storage device 100 may calculate a total sum of sizes of the first data units DU_1 stored in the buffer BUF (S510).

The controller 120 determines whether the total sum of the sizes calculated in the step S510 is equal to or greater than a threshold size (S520).

For example, the controller 120 may determine the threshold size as the total sum of the sizes of first data units DU_1 capable of being read in parallel from the memory 110.

When the total sum of the sizes is equal to or greater than the threshold size (S520-Y), the controller 120 may store the first data units DU_1 stored in the buffer BUF in the random read memory area (S530).

In the case of the randomly read first data units DU_1, there is a high possibility that they will be randomly read in a similar pattern thereafter. In this case, by storing the first data units DU_1 with a high possibility to be randomly read in a separate location to be suitable for random reading, the controller 120 may further improve random read performance when subsequently receiving a random read request for the first data units DU_1. This is because data is sequentially stored in the plurality of memory areas MEM_AREA and thus the plurality of memory areas MEM_AREA may not be a structure suitable for storing randomly read data.

The controller 120 may first transmit the first data units DU_1 to the host HOST, and then, may write the first data units DU_1 to the random read memory area.

On the other hand, when the total sum of the sizes is smaller than the threshold size (S520-N), the controller 120 may not store the first data units DU_1 in the random read memory area (S540). In this case, after transmitting the first data units DU_1 to the host HOST, the controller 120 may delete the first data units DU_1 stored in the buffer BUF.

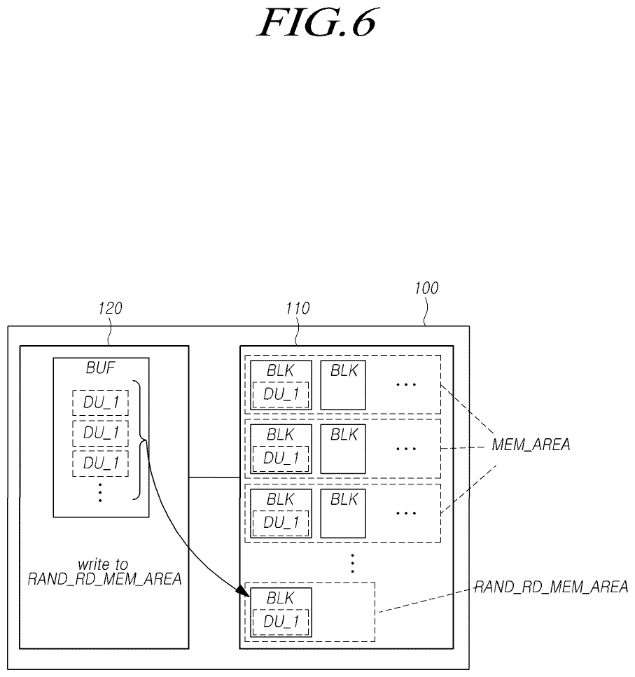

FIG. 6 is a diagram illustrating an operation in which a storage device (e.g., the storage device 100) writes first data units DU_1 to a random read memory area RAND_RD_MEM_AREA, according to an embodiment of the present disclosure.

Referring to FIG. 6, the controller 120 of the storage device 100 may write first data units DU_1 stored in the buffer BUF to a random read memory area RAND_RD_MEM_AREA.

In the memory 110, the random read memory area RAND_RD_MEM_AREA exists separately from the plurality of memory areas MEM_AREA. The first data units DU_1 are stored in the plurality of memory areas MEM_AREA, and are also stored in the random read memory area RAND_RD_MEM_AREA.

Since the first data units DU_1 stored in the random read memory area RAND_RD_MEM_AREA are data units which are randomly read, the controller 120 may generate a separate map table for the random read memory area RAND_RD_MEM_AREA suitable for random reading.

In embodiments of the present disclosure, the controller 120 may generate a random read map table which indicates mapping information between at least one logical address and at least one physical address of the random read memory area RAND_RD_MEM_AREA.

The controller 120 may add, to the random read map table, mapping information between logical addresses corresponding to the first data units DU_1 and physical addresses where the first data units DU_1 are stored in the random read memory area RAND_RD_MEM_AREA.

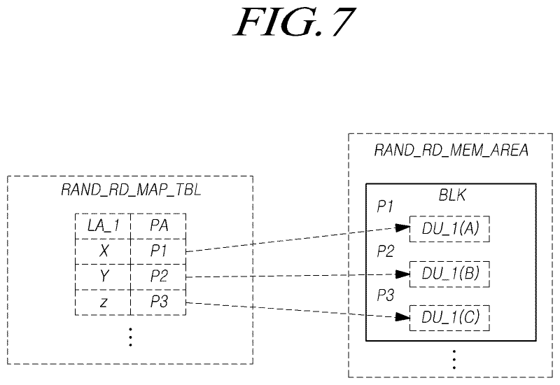

This will be described below in detail with reference to FIG. 7.

FIG. 7 is a diagram illustrating a random read map table RAND_RD_MAP_TBL according to an embodiment of the present disclosure.

Referring to FIG. 7, the random read map table RAND_RD_MAP_TBL may indicate mapping information between first target logical addresses LA_1 and physical addresses PA where the first data units DU_1 are stored in the random read memory area RAND_RD_MEM_AREA. The first target logical addresses LA_1 are logical addresses corresponding to the first data units DU_1 which are stored in the random read memory area RAND_RD_MEM_AREA.

In FIG. 7, the random read map table RAND_RD_MEM_TBL indicates that a first target logical address (or a first one of the first target logical addresses) X is mapped to a physical address P1 where a first data unit (or a first one of the first data units) DU_1(A) is stored. Therefore, upon receiving a random read request for the first target logical address X, the controller 120 reads the first data unit DU_1(A) which is stored at the physical address P1.

The random read map table RAND_RD_MEM_TBL indicates that a first target logical address (or a second one of the first target logical addresses) Y is mapped to a physical address P2 where a first data unit (or a second one of the first data units) DU_1(B) is stored. Therefore, upon receiving a random read request for the first target logical address Y, the controller 120 reads the first data unit DU_1(B) which is stored at the physical address P2.

The random read map table RAND_RD_MEM_TBL indicates that a first target logical address (or a third one of the first target logical addresses) Z is mapped to a physical address P3 where a first data unit (or a third one of the first data units) DU_1(C) is stored. Therefore, upon receiving a random read request for the first target logical address Z, the controller 120 reads the first data unit DU_1(C) which is stored at the physical address P3.

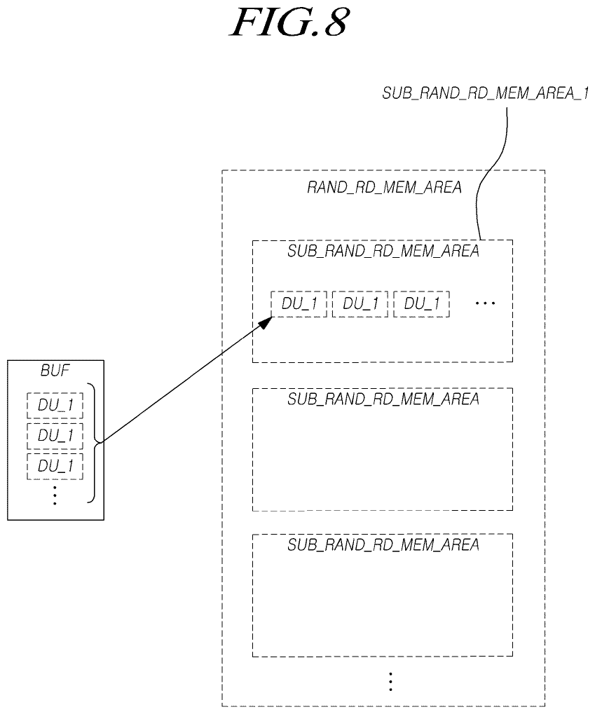

FIG. 8 is a diagram illustrating sub-random read memory areas SUB_RAND_RD_MEM_AREA included in a random read memory area RAND_RD_MEM_AREA according to an embodiment of the present disclosure.

Referring to FIG. 8, the random read memory area RAND_RD_MEM_AREA may include a plurality of sub-random read memory areas SUB_RAND_RD_MEM_AREA.

The plurality of sub-random read memory areas SUB_RAND_RD_MEM_AREA may be determined in various ways. For example, each sub-random read memory area may be a part of a single memory block which is included in the random read memory area RAND_RD_MEM_AREA. For another example, each sub-random read memory area may be configured with at least one memory block which is included in the random read memory area RAND_RD_MEM_AREA.

When storing the first data units DU_1 stored in the buffer BUF in the random read memory area RAND_RD_MEM_AREA, the controller 120 of the storage device 100 may store the first data units DU_1 in a first sub-random read memory area SUB_RAND_RD_MEM_AREA_1 among the plurality of sub-random read memory areas SUB_RAND_RD_MEM_AREA.

There is a free space for storing the first data units DU_1 in the first sub-random read memory area SUB_RAND_RD_MEM_AREA_1. In other words, the first sub-random read memory area has a free space suitable for storing the first data units DU_1.

In the above, an operation in which the storage device 100 receives the first random read request RAND_RD_1 for the plurality of first target logical addresses LA_1 and stores the randomly read first data units DU_1 in the random read memory area RAND_RD_MEM_AREA has been described.

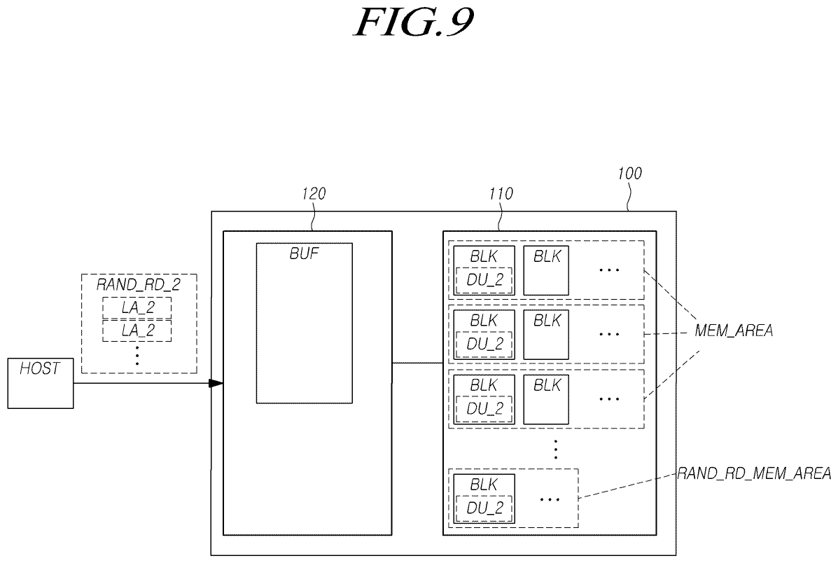

Hereafter, an operation in which, after processing the first random read request RAND_RD_1, the storage device 100 receives a new second random read request from the host HOST and processes the new second random read request will be described with reference to FIG. 9.

FIG. 9 is a diagram illustrating an operation in which a storage device (e.g., the storage device 100) processes a second random read request RAND_RD_2 according to an embodiment of the present disclosure.

Referring to FIG. 9, the controller 120 of the storage device 100 may receive a second random read request RAND_RD_2 from the outside (e.g., the host HOST) of the storage device 100. The second random read request RAND_RD_2 may include a plurality of second target logical addresses LA_2.

Second data units DU_2 may be stored in the plurality of memory areas MEM_AREA, and may also be stored in the random read memory area RAND_RD_MEM_AREA.

Therefore, the controller 120 may read the second data units DU_2 from the plurality of memory areas MEM_AREA, or the random read memory area RAND_RD_MEM_AREA, or both.

Hereinbelow, a specific method in which the controller 120 reads the second data units DU_2 will be described.

In embodiments of the present disclosure, the controller 120 may calculate a hit rate, as a rate at which the second data units DU_2 corresponding to the plurality of second target logical addresses LA_2 are searched for, for each of the plurality of sub-random read memory areas SUB_RAND_RD_MEM_AREA. For example, a hit rate is a ratio of a number of the second data units DU_2 stored in each of the sub-random read memory areas SUB_RAND_RD_MEM_AREA over a number of all data units stored in each of the sub-random read memory areas SUB_RAND_RD_MEM_AREA.

For example, when the controller 120 succeeds in searching for second data units DU_2 corresponding to three of four second target logical addresses LA_2 for a specific sub-random read memory area, the hit rate of the corresponding sub-random read memory area is ¾=75%.

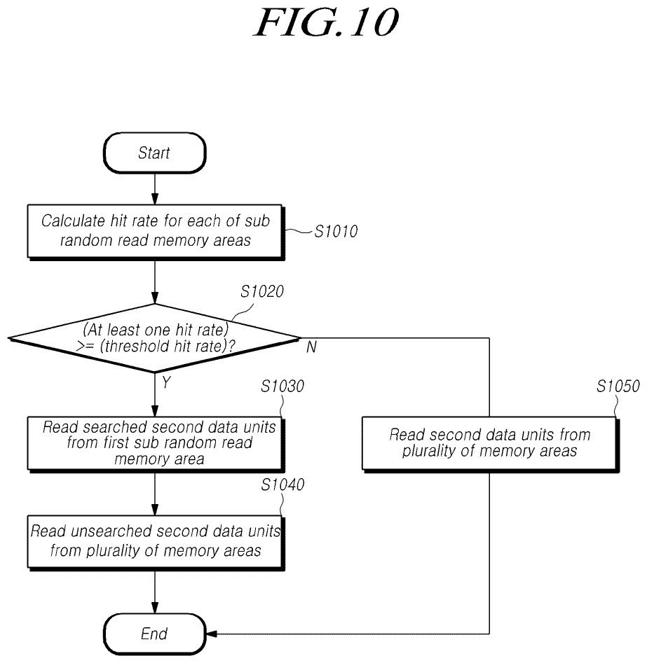

On the basis of the calculated hit rate of each of the plurality of sub-random read memory areas SUB_RAND_RD_MEM_AREA, the controller 120 may read the second data units DU_2 from the plurality of memory areas MEM_AREA, or the random read memory area RAND_RD_MEM_AREA, or both. This will be described below in detail with reference to FIG. 10.

FIG. 10 is a diagram illustrating an operation in which a storage device (e.g., the storage device 100) reads second data units DU_2 according to an embodiment of the present disclosure.

Referring to FIG. 10, the controller 120 of the storage device 100 may calculate the hit rate of each of the plurality of sub-random read memory areas SUB_RAND_RD_MEM_AREA (S1010).

The controller 120 determines whether the hit rate of at least one of the plurality of sub-random read memory areas SUB_RAND_RD_MEM_AREA calculated in the step S1010 is equal to or greater than a set threshold hit rate (S1020).

When the hit rate of at least one of the plurality of sub-random read memory areas (e.g., a first sub-random read memory area) SUB_RAND_RD_MEM_AREA is equal to or greater than the threshold hit rate (S1020-Y), the controller 120 may read a portion of second data units DU_2 searched for in the first sub-random read memory area from the first sub-random read memory area (1030). The hit rate of the first sub-random read memory area may be equal to or greater than the threshold hit rate.

For example, the first sub-random read memory area may have a highest hit rate among the plurality of sub-random read memory areas SUB_RAND_RD_MEM_AREA.

A case where data units A, B, C and D, data units A, B, F and G and data units B, C, F and H are stored in three sub-random read memory areas SUB_RAND_RD_MEM_AREA, respectively, will be described as an example. When a threshold hit rate is 75% and the controller 120 reads second data units DU_2 A, B, C and E, the controller 120 may determine that the hit rates of the respective three sub-random read memory areas SUB_RAND_RD_MEM_AREA are 75% (the data units A, B and C are searched for), 50% (the data units A and B are searched for) and 50% (the data units B and C are searched for).

Therefore, the controller 120 may read the data units A, B and C in a sub-random read memory area where the data units A, B, C and D are stored and whose hit rate is equal to or greater than the threshold hit rate of 75%.

The controller 120 may read the remaining portion of the second data units DU_2 which are not searched for (e.g., the remaining portion of the second data units DU_2 that does not match the data units in the first sub-random read memory area) in the first sub-random read memory area among the second data units DU_2, from the plurality of memory areas MEM_AREA (S1040).

On the other hand, when each of the hit rates of the plurality of sub-random read memory areas SUB_RAND_RD_MEM_AREA is less than the threshold hit rate (S1020-N), the controller 120 may read the second data units DU_2 from the plurality of memory areas MEM_AREA (S1050).

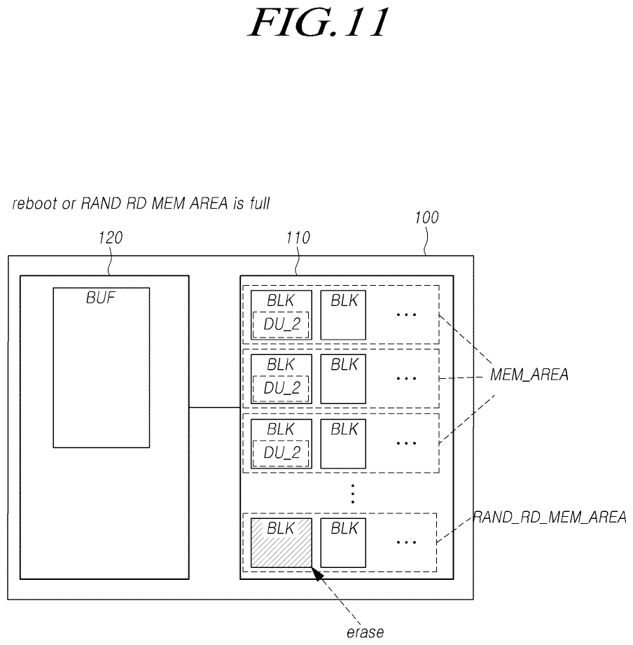

A memory block which is included in the random read memory area RAND_RD_MEM_AREA may be erased when a specific condition is satisfied. This will be described below in detail with reference to FIG. 11.

FIG. 11 is a diagram illustrating an operation in which a storage (e.g., the storage device 100) erases a memory block included in the random read memory area RAND_RD_MEM_AREA according to an embodiment of the present disclosure.

Referring to FIG. 11, when the storage device 100 is rebooted or when a size of free spaces of memory blocks (e.g., all memory blocks) included in the random read memory area RAND_RD_MEM_AREA is smaller than a threshold size, the controller 120 of the storage device 100 may erase at least one memory block among the memory blocks included in the random read memory area RAND_RD_MEM_AREA.

For example, the controller 120 may erase, among the memory blocks included in the random read memory area RAND_RD_MEM_AREA, a memory block in which a data unit storage time (i.e., a retention time) is longest or a memory block in which a total sum of read counts of stored data units is smallest.

When the number of memory blocks included in the random read memory area RAND_RD_MEM_AREA is 1, the controller 120 may determine in another way whether to erase the memory block included in the random read memory area RAND_RD_MEM_AREA.

For example, when the ratio of data units searched for in the random read memory area RAND_RD_MEM_AREA among data units requested in random read requests received from the outside (e.g., the host HOST) of the storage device 100 for a predetermined time period is less than a threshold value, the controller 120 may erase the memory block included in the random read memory area RAND_RD_MEM_AREA. Specifically, when a ratio of a number of data units requested in a plurality of random read requests over a total number of the requested data units for a predetermined time period is less than a threshold value, the controller 120 may erase the memory block included in the random read memory area. The plurality of random read requests may be received from the outside of the storage device for the predetermined time period. This is because when data units with a low search ratio are stored in the random read memory area RAND_RD_MEM_AREA, increase in random read performance due to the presence of the random read memory area RAND_RD_MEM_AREA may not be significant.

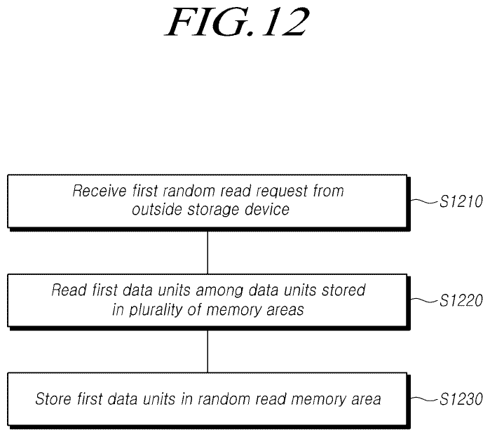

FIG. 12 is a diagram illustrating a method for operating a storage device (e.g., the storage device 100) according to an embodiment of the present disclosure.

Referring to FIG. 12, a method for operating the storage device 100 may include step S1210 of receiving a first random read request RAND_RD_1 from outside the storage device 100.

The method for operating the storage device 100 may include step S1220 of reading first data units DU_1 among data units stored in a plurality of memory areas MEM_AREA in response to the first random read request RAND_RD_1, each of the plurality of memory areas including one or more memory blocks among a plurality of memory blocks BLK.

The method for operating the storage device 100 may include step S1230 of storing the first data units DU_1 in a random read memory area RAND_RD_MEM_AREA. The random read memory area RAND_RD_MEM_AREA may include one or more memory blocks and be separate from the plurality of memory areas MEM_AREA.

For example, step S1230 may include storing the first data units DU_1 in a buffer BUF, and when the total sum of the sizes of the first data units DU_1 stored in the buffer BUF is equal to or greater than a threshold size, the first data units DU_1 may be stored in the random read memory area RAND_RD_MEM_AREA.

For example, the threshold size may be the total sum of the sizes of data units capable of being read in parallel from the memory 110.

For example, the random read memory area RAND_RD_MEM_AREA may include a plurality of sub-random read memory areas SUB_RAND_RD_MEM_AREA. The step S1230 may include storing the first data units DU_1 in a specific sub-random read memory area (e.g., a first sub-random read memory area SUB_RAND_RD_MEM_AREA_1) among the plurality of sub-random read memory areas SUB_RAND_RD_MEM_AREA. The first sub-random read memory area SUB_RAND_RD_MEM_AREA_1 may have a free space for storing the first data units DU_1.

The method for operating the storage device 100 may further include step of receiving a second random read request RAND_RD_2 from outside the storage device 100; and step of calculating a hit rate, as a rate at which second data units DU_2 corresponding to the second random read request RAND_RD_2 are searched for, for each of the plurality of sub-random read memory areas SUB_RAND_RD_MEM_AREA. For example, the hit rate may be a ratio of a number of data units stored in each of the sub-random read memory areas SUB_RAND_RD_MEM_AREA that match the second data units DU_2 over a number of all data units stored in each of the sub-random read memory areas SUB_RAND_RD_MEM_AREA. The method may further include step of reading, on the basis of the hit rate of each of the plurality of sub-random read memory areas SUB_RAND_RD_MEM_AREA, the second data units DU_2 from the plurality of memory areas MEM_AREA, or the random read memory area RAND_RD_MEM_AREA, or both.

For example, when the hit rate of at least one (e.g., a first sub-random read memory area SUB_RAND_RD_MEM_AREA_1) among the plurality of sub-random read memory areas SUB_RAND_RD_MEM_AREA is equal to or greater than a set threshold hit rate, the step of reading the second data units DU_2 may include reading a portion of the second data units DU_2 from the first sub-random read memory area SUB_RAND_RD_MEM_AREA_1, the portion of the second data units DU_2 matching data units stored in the first sub-random read memory area SUB_RAND_RD_MEM_AREA_1, and may include reading the remaining portion of the second data units DU_2 from the plurality of memory areas MEM_AREA. The hit rate of the first sub-random read memory area SUB_RAND_RD_MEM_AREA_1 is equal to or greater than the threshold hit rate.

For another example, when each of the hit rates of all of the plurality of sub-random read memory areas SUB_RAND_RD_MEM_AREA is less than the threshold hit rate, the second data units DU_2 may be read from the plurality of memory areas MEM_AREA.

The method for operating the storage device 100 may further include erasing, when the storage device 100 is rebooted or when a size of the free spaces of all memory blocks included in the random read memory area RAND_RD_MEM_AREA is smaller than a threshold size, at least one memory block among the memory blocks included in the random read memory area RAND_RD_MEM_AREA.

Although some embodiments of the disclosure have been described for illustrative purposes, those skilled in the art will appreciate that various modifications, additions and substitutions are possible.

What is claimed is:

1. A storage device comprising:
a memory including a plurality of memory blocks and being configured to store data in the plurality of memory blocks; and
a controller configured to set a plurality of memory areas each including one or more memory blocks among the plurality of memory blocks, receive a first random read request from an outside of the storage device, read first data units among data units stored in the plurality of memory areas from the memory in response to the first random read request to transmit the first data units to the outside of the storage device, and store the first data units in a random read memory area, the random read memory area including one or more memory blocks and being separate from the plurality of memory areas.

2. The storage device according to claim 1, wherein:
the controller stores the first data units in a buffer; and
when a total sum of sizes of the first data units stored in the buffer is equal to or greater than a threshold size, the controller stores the first data units in the random read memory area.

3. The storage device according to claim 2, wherein the controller determines the threshold size as a total sum of sizes of data units capable of being read in parallel from the memory.

4. The storage device according to claim 1, wherein:
the controller generates a random read map table which indicates mapping information between at least one logical address and at least one physical address of the random read memory area; and
the controller adds, to the random read map table, mapping information between logical addresses corresponding to the first data units and physical addresses where the first data units are stored in the random read memory area.

5. The storage device according to claim 1, wherein:
the random read memory area includes a plurality of sub-random read memory areas; and
the controller stores the first data units in a specific sub-random read memory area among the plurality of sub-random read memory areas, the specific sub-random read memory area having a free space for storing the first data units.

6. The storage device according to claim 5, wherein the controller:
receives a second random read request from the outside of the storage device;
calculates a hit rate for each of the plurality of sub-random read memory areas, the hit rate being a ratio of a number of second data units stored in each of the sub-random read memory areas over a number of all data units stored in each of the sub-random read memory areas, the second data units corresponding to the second random read request; and
reads the second data units from the plurality of memory areas, or the random read memory area, or both, on the basis of the hit rate of each of the plurality of sub-random read memory areas.

7. The storage device according to claim 6, wherein when the hit rate of a first sub-random read memory area among the plurality of sub-random read memory areas is equal to or greater than a set threshold hit rate, the controller reads a portion of the second data units stored in the first sub-random read memory area from the first sub-random read memory area, and reads the remaining portion of the second data units from the plurality of memory areas.

8. The storage device according to claim 7, wherein the first sub-random read memory area has a highest hit rate among the plurality of sub-random read memory areas.

9. The storage device according to claim 6, wherein when each of the hit rates of the plurality of sub-random read memory areas is less than the threshold hit rate, the controller reads the second data units from the plurality of memory areas.

10. The storage device according to claim 1, wherein when the storage device is rebooted or when a size of free spaces of the memory blocks included in the random read memory area is smaller than a threshold size, the controller erases at least one memory block among the memory blocks included in the random read memory area.

11. The storage device according to claim 10, wherein the controller erases, among the memory blocks included in the random read memory area, a memory block in which a data unit is stored for a longest time or a memory block in which a total sum of read counts of stored data units is smallest.

12. The storage device according to claim 10, wherein when a ratio of a number of data units requested in a plurality of random read requests over a total number of the requested data units for a predetermined time period is less than a threshold value, the plurality of random read requests being received from the outside of the storage device for a predetermined time period, the controller erases memory block included in the random read memory area.

13. A method for operating a storage device including a memory including a plurality of memory blocks, comprising:
receiving a first random read request from an outside of the storage device;
reading first data units among data units stored in a plurality of memory areas in response to the first random read request, each of the plurality of memory areas including one or more memory blocks among the plurality of memory blocks; and
storing the first data units in a random read memory area that includes one or more memory blocks and is separate from the plurality of memory areas.

14. The method according to claim 13, wherein storing the first data units in the random read memory area includes storing the first data units in a buffer, and
wherein, when a total sum of sizes of the first data units stored in the buffer is equal to or greater than a threshold size, the first data units are stored in the random read memory area.

15. The method according to claim 14, wherein the threshold size is a total sum of sizes of data units capable of being read in parallel from the memory.

16. The method according to claim 13, wherein:
the random read memory area includes a plurality of sub-random read memory areas; and
storing the first data units in the random read memory area includes storing the first data units in a specific sub-random read memory area among the plurality of sub-random read memory areas, the specific sub-random read memory area having a free space for storing the first data units.

17. The method according to claim 16, further comprising:
receiving a second random read request from the outside of the storage device;
calculating, for each of the plurality of sub-random read memory areas, a hit rate being a ratio of a number of second data units stored in each of the sub-random read memory areas over a number of all data units stored in each of the sub-random read memory areas, the second data units corresponding to the second random read request; and
reading the second data units from the plurality of memory areas, or the random read memory area, or both, on the basis of the hit rate of each of the plurality of sub-random read memory areas.

18. The method according to claim 17, wherein, when the hit rate of a first sub-random read memory area among the plurality of sub-random read memory areas is equal to or greater than a set threshold hit rate, reading the second data units includes:
reading a portion of the second data units stored in the first sub-random read memory area from the first sub-random read memory area; and
reading the remaining portion of the second data units from the plurality of memory areas.

19. The method according to claim 17, wherein when each of the hit rates of the plurality of sub-random read memory areas is less than the threshold hit rate, the second data units are read from the plurality of memory areas.

20. The method according to claim 13, further comprising:
erasing, when the storage device is rebooted or when a size of free spaces of the memory blocks included in the random read memory area is smaller than a threshold size, at least one memory block among the memory blocks included in the random read memory area.
